(19) United States
(12) Patent Application Publication
(10) Pub. No.: US 2012/0284658 A1
(43) Pub. Date: Nov. 8, 2012

(54) METHODS AND APPARATUSES FOR FACILITATING MANAGEMENT OF WIDGETS

(75) Inventor: Ari-Pekka Hirvonen, Helsinki (FI)

(73) Assignee: Nokia Corporation

(21) Appl. No.: 13/099,771

(22) Filed: May 3, 2011

(51) Int. Cl. G06F 3/048

(52) U.S. Cl. 715/779

(57) ABSTRACT

Methods and apparatuses are provided for facilitating management of widgets. A method may include determining a selection of a graphical widget displayed in a widget tray for addition to a home screen. The widget tray may contain one or more widgets available to add to the home screen and may be displayed concurrently with at least a portion of the home screen. The selected graphical widget may be displayed in the widget tray with an appearance substantially similar to how the selected graphical widget would appear if added to the home screen. The method may further include, responsive to the selection of the graphical widget, causing the selected graphical widget to be added to the home screen. Corresponding apparatuses are also provided.

### TECHNOLOGICAL FIELD

Example embodiments of the present invention relate generally to user interface technology and and, more particularly, relate to methods and apparatuses for facilitating management of widgets.

### BACKGROUND

The modern computing era has brought about a tremendous expansion in computing power as well as increased affordability of computing devices. This expansion in computing power has led to a reduction in the size of computing devices and given rise to a new generation of mobile devices that are capable of performing functionality that only a few years ago required processing power provided only by the most advanced desktop computers. Consequently, mobile computing devices having a small form factor have become ubiquitous and are used by consumers of all socioeconomic backgrounds.

Modern mobile computing devices frequently have displays, which while still much smaller than a desktop display, have a relatively large surface area given the compact size of such mobile computing devices. Many of these displays are capable of displaying a rich color pallet, which may enable display of a feature rich user interface to a user. Some mobile computing devices leverage modern displays to enable the display of widgets. These widgets may, for example, comprise small, stand-alone applications that may include a graphical user interface (e.g., a graphical widget) that may be displayed on a screen of a computing device. By way of example, some widgets may include a clock widget, a weather widget, a widget indicating whether a user has received a recent email, or the like. Depending on device display size and the size of respective graphical widgets, multiple graphical widgets may be displayed concurrently on a display. Further, as many widgets have a relatively small memory footprint, widgets may be run in the background without significantly impacting usage of relatively larger, dedicated applications that a user may run from time-to-time. Accordingly, widgets may provide a user with quick access to various types of information without requiring the user to launch a larger dedicated application each time the user desires to see information and/or use functionality provided by a widget.

However, to date user interface technology for management of widgets has generally not been user friendly. Accordingly some computing device users have not fully embraced the use of widgets due to the lack of user friendly interfaces for widget management.

### BRIEF SUMMARY

Methods, apparatuses, and computer program products are herein provided for facilitating widget management. Methods, apparatuses, and computer program products in accordance with various embodiments may provide several advantages to computing devices, computing device users, and widget developers. Some example embodiments advantageously facilitate user friendly management of graphical widgets displayed on a home screen of a device. In this regard, some example embodiments provide for a streamlined selection of a graphical widget for addition to a home screen from a widget tray containing available widgets. The widget tray of some example embodiments displays available widgets in a graphical form substantially similar to how they would appear on the home screen, if added to the home screen. Accordingly, selection and preview of widgets may be integrated into a streamlined user interface without requiring a user to navigate through several text dialogs and pop-up menus in order to select and place a widget on a home screen. As such, users may find management of widgets using various embodiments disclosed herein to be more user friendly than prior interfaces for widget management. Widget developers may benefit because barriers to adoption of their widgets may be reduced, as users may be more likely to use widgets due to the more user friendly widget management facilitated by some example embodiments.

In a first example embodiment, a method is provided, which may comprise determining a selection of a graphical widget displayed in a widget tray for addition to a home screen. The widget tray may contain one or more widgets available to add to the home screen and may be displayed concurrently with at least a portion of the home screen. The selected graphical widget may be displayed in the widget tray with an appearance substantially similar to how the selected graphical widget would appear if added to the home screen. The method of this example embodiment may further comprise, responsive to the selection of the graphical widget, causing the selected graphical widget to be added to the home screen.

In another example embodiment, an apparatus comprising at least one processor and at least one memory storing computer program code is provided. The at least one memory and stored computer program code may be configured, with the at least one processor, to cause the apparatus of this example embodiment to at least determine a selection of a graphical widget displayed in a widget tray for addition to a home screen. The widget tray may contain one or more widgets available to add to the home screen and may be displayed concurrently with at least a portion of the home screen. The selected graphical widget may be displayed in the widget tray with an appearance substantially similar to how the selected graphical widget would appear if added to the home screen. The at least one memory and stored computer program code may be configured, with the at least one processor, to further cause the apparatus of this example embodiment, responsive to the selection of the graphical widget, to cause the selected graphical widget to be added to the home screen.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method. The method of this example embodiment may comprise determining a selection of a graphical widget displayed in a widget tray for addition to a home screen. The widget tray may contain one or more widgets available to add to the home screen and may be displayed concurrently with at least a portion of the home screen. The selected graphical widget may be displayed in the widget tray with an appearance substantially similar to how the selected graphical widget would appear if added to the home screen. The method of this example embodiment may further comprise, responsive to the selection of the graphical widget, causing the selected graphical widget to be added to the home screen.

In another example embodiment, an apparatus is provided that may comprise means for determining a selection of a graphical widget displayed in a widget tray for addition to a home screen. The widget tray may contain one or more widgets available to add to the home screen and may be displayed concurrently with at least a portion of the home screen. The selected graphical widget may be displayed in the widget tray with an appearance substantially similar to how the selected graphical widget would appear if added to the home screen. The apparatus of this example embodiment may further comprise means for, responsive to the selection of the graphical widget, causing the selected graphical widget to be added to the home screen.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the invention in any way. It will be appreciated that the scope of the invention encompasses many potential embodiments, some of which will be further described below, in addition to those here summarized.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates management of widgets on a home screen according to an existing user interface;

FIG. 2 illustrates a block diagram of an apparatus for facilitating management of widgets according to some example embodiments;

FIG. 3 is a schematic block diagram of a mobile terminal according to some example embodiments;

FIGS. 4a-4h illustrate screen captures according to an example process flow for adding a widget to a home screen according to some example embodiments;

FIGS. 5a-5d illustrate screen captures according to an example process flow for removing a widget from a home screen according to some example embodiments;

FIG. 6 illustrates a flowchart according to an example method for facilitating management of widgets according to some example embodiments; and

FIG. 7 illustrates a flowchart according to another example method for facilitating management of widgets according to some example embodiments.

### DETAILED DESCRIPTION

Some embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to data capable of being transmitted, received, displayed and/or stored in accordance with various example embodiments. Thus, use of any such terms should not be taken to limit the spirit and scope of the disclosure. Further, where a computing device is described herein to receive data from another computing device, it will be appreciated that the data may be received directly from the another computing device or may be received indirectly via one or more intermediary computing devices, such as, for example, one or more servers, relays, routers, network access points, base stations, and/or the like.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Examples of non-transitory computer-readable media include a floppy disk, hard disk, magnetic tape, any other non-transitory magnetic medium, a compact disc read only memory (CD-ROM), compact disc compact disc-rewritable (CD-RW), digital versatile disc (DVD), Blu-Ray, any other non-transitory optical medium, a random access memory (RAM), a programmable read only memory (PROM), an erasable programmable read only memory (EPROM), a FLASH-EPROM, any other memory chip or cartridge, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

In many existing phones having customizable home screens with widgets, the list of widgets that the user can add to the homescreen is presented by an entirely text-based list or dialog. In this regard widgets for addition to a home screen are currently accessed by a menu and the widgets are generally placed to the home screen by selection of a textual identifier referencing a widget with an OK/Cancel buttons. Accordingly, the menu for selecting from available widgets does not provide the user with any preview of how the widget will appear when added to the home screen.

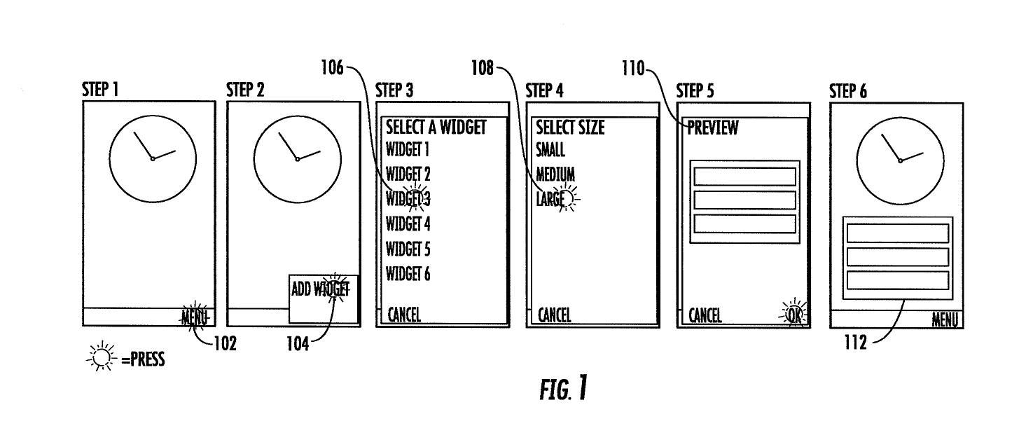

For example, FIG. 1 illustrates management of widgets on a home screen according to one such existing user interface. In this regard, as an initial step, the user may select to view a menu 102 from a home screen of the device. The selected menu may provide one or more options, including an option to add a widget 104. Selection of the option to add a widget results in display of a text-menu 106 listing text identifiers for available widgets (e.g., “widget 1,” “widget 2,” “widget 3,” etc.). If the user selects one of the text identifiers for a widget, the user may be presented with a menu 108 to select a display size for the widget (e.g., “small,” “medium,” or “large”). It will be appreciated that to this point, the user has not been presented with a preview of the graphical appearance of the widget as it would appear if added to the home screen. Once the user selects the desired size for the widget from the menu 108, the user may be provided with a preview 110 of how the selected widget having the selected size would appear if added to the home screen. If the user confirms after viewing the preview 110 that he/she would like to add the selected widget to the home screen, then the final widget 112 may be added to the home screen. In this regard, in many existing devices, the user pattern for adding a widget to a home screen may approximate the following flow: menu button→list→dialog (widget preview)→ok button→done. Accordingly, existing interfaces for widget management may frustrate users due to navigation through several menus and steps that may not even provide the user with a preview of the widget's appearance until late in the process.

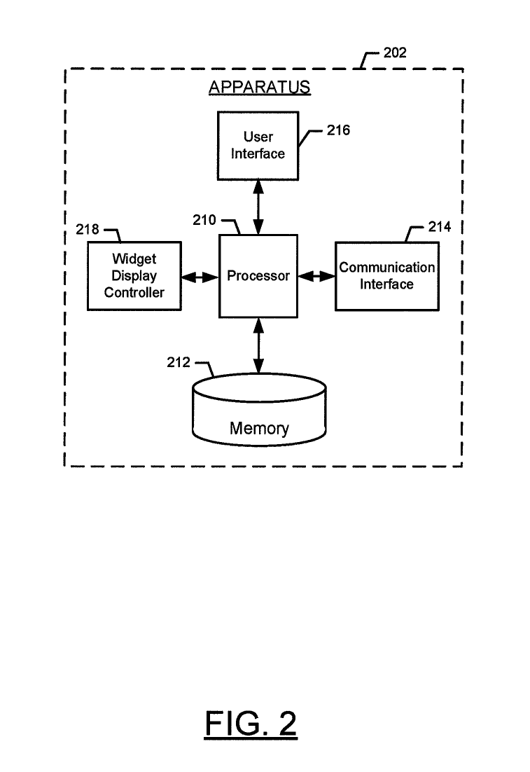

Some example embodiments disclosed herein may accordingly offer improvements over existing interfaces for management of widgets. Referring now to FIG. 2, FIG. 2 illustrates a block diagram of an apparatus 202 for facilitating management of widgets according to some example embodiments. It will be appreciated that the apparatus 202 is provided as an example of some embodiments and should not be construed to narrow the scope or spirit of the invention in any way. In this regard, the scope of the disclosure encompasses many potential embodiments in addition to those illustrated and described herein. As such, while FIG. 2 illustrates one example of a configuration of an apparatus for facilitating management of widgets, other configurations may also be used to implement embodiments of the present invention.

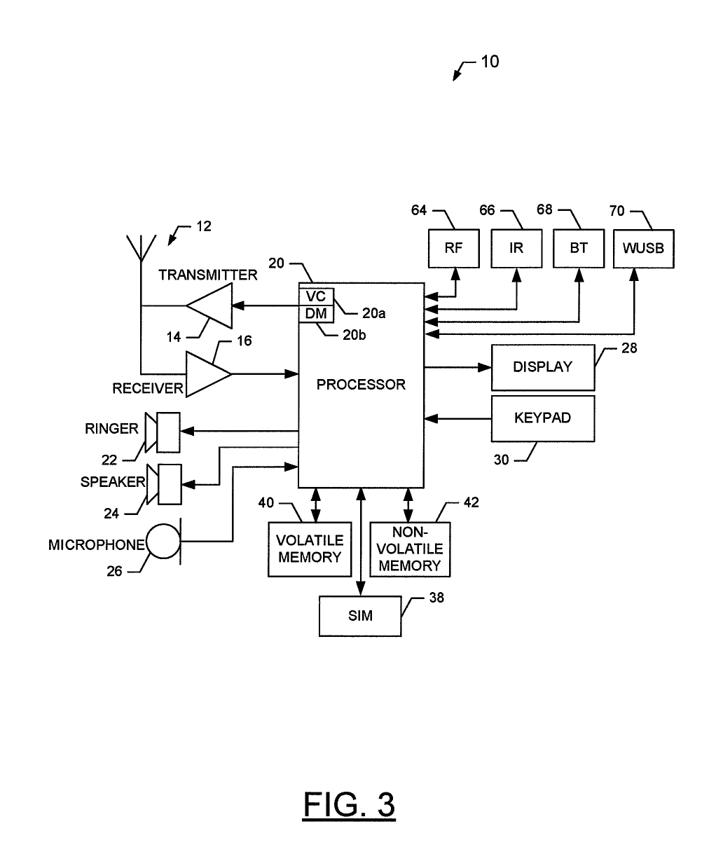

The apparatus 202 may be embodied as a desktop computer, laptop computer, mobile terminal, mobile computer, mobile phone, mobile communication device, game device, digital camera/camcorder, audio/video player, television device, digital video recorder, positioning device, chipset, a computing device comprising a chipset, any combination thereof, and/or the like. In this regard, the apparatus 202 may comprise any computing device or other apparatus that is configured to facilitate management of widgets in accordance with one or more example embodiments disclosed herein. In some example embodiments, the apparatus 202 is embodied as a mobile computing device, such as the mobile terminal illustrated in FIG. 3.

In this regard, FIG. 3 illustrates a block diagram of a mobile terminal 10 representative of some embodiments of an apparatus 202. It should be understood, however, that the mobile terminal 10 illustrated and hereinafter described is merely illustrative of one type of apparatus 202 that may implement and/or benefit from various embodiments of the invention and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 3 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), future communication, and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of operating according to Wi-Fi or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The user input interface may comprise devices allowing the mobile terminal to receive data, such as a keypad 30, a touch display (not shown), a joystick (not shown), and/or other input device. In embodiments including a keypad, the keypad may comprise numeric (0-9) and related keys (#, *), and/or other keys for operating the mobile terminal.

As shown in FIG. 3, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to ultra-low power Bluetooth™ technology (e.g., Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. Although not shown, the mobile terminal may be capable of transmitting and/or receiving data from electronic devices according to various wireless networking techniques, including Wi-Fi, WLAN techniques such as IEEE 802.11 techniques, IEEE 802.15 techniques, IEEE 802.16 techniques, and/or the like.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. One or more of the volatile memory 40 or non-volatile memory 42 may be embodied as a tangible, non-transitory memory. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 2, in some example embodiments, the apparatus 202 includes various means for performing the various functions herein described. These means may comprise one or more of a processor 210, memory 212, communication interface 214, user interface 216, or widget display controller 218. The means of the apparatus 202 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 212) that is executable by a suitably configured processing device (e.g., the processor 210), or some combination thereof.

In some example embodiments, one or more of the means illustrated in FIG. 2 may be embodied as a chip or chip set. In other words, the apparatus 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 210, memory 212, communication interface 214, user interface 216, and/or widget display controller 218 may be at least partially embodied as a chip or chip set. The apparatus 202 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 210 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other types of hardware processors, or some combination thereof. Accordingly, although illustrated in FIG. 2 as a single processor, in some embodiments the processor 210 comprises a plurality of processors. The plurality of processors may be in operative communication with each other and may be collectively configured to perform one or more functionalities of the apparatus 202 as described herein. The plurality of processors may be embodied on a single computing device or distributed across a plurality of computing devices collectively configured to function as the apparatus 202. In embodiments wherein the apparatus 202 is embodied as a mobile terminal 10, the processor 210 may be embodied as or comprise the processor 20. In some example embodiments, the processor 210 is configured to execute instructions stored in the memory 212 or otherwise accessible to the processor 210. These instructions, when executed by the processor 210, may cause the apparatus 202 to perform one or more of the functionalities of the apparatus 202 as described herein. As such, whether configured by hardware or software methods, or by a combination thereof, the processor 210 may comprise an entity capable of performing operations according to one or more example embodiments while configured accordingly. Thus, for example, when the processor 210 is embodied as an ASIC, FPGA or the like, the processor 210 may comprise specifically configured hardware for conducting one or more operations described herein. Alternatively, as another example, when the processor 210 is embodied as an executor of instructions, such as may be stored in the memory 212, the instructions may specifically configure the processor 210 to perform one or more algorithms and operations described herein.

The memory 212 may comprise, for example, volatile memory, non-volatile memory, or some combination thereof. In this regard, the memory 212 may comprise a non-transitory computer-readable storage medium. Although illustrated in FIG. 2 as a single memory, the memory 212 may comprise a plurality of memories. The plurality of memories may be embodied on a single computing device or may be distributed across a plurality of computing devices collectively configured to function as the apparatus 202. In various example embodiments, the memory 212 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 202 is embodied as a mobile terminal 10, the memory 212 may comprise the volatile memory 40 and/or the non-volatile memory 42. The memory 212 may be configured to store information, data, applications, instructions, or the like for enabling the apparatus 202 to carry out various functions in accordance with various example embodiments. For example, in some example embodiments, the memory 212 is configured to buffer input data for processing by the processor 210. Additionally or alternatively, the memory 212 may be configured to store program instructions for execution by the processor 210. The memory 212 may store information in the form of static and/or dynamic information. The stored information may include, for example, images captured for use in generating a panoramic image. This stored information may be stored and/or used by the widget display controller 218 during the course of performing its functionalities.

The communication interface 214 may be embodied as any device or means embodied in circuitry, hardware, a computer program product comprising computer readable program instructions stored on a computer readable medium (e.g., the memory 212) and executed by a processing device (e.g., the processor 210), or a combination thereof that is configured to receive and/or transmit data from/to another computing device. In an example embodiment, the communication interface 214 is at least partially embodied as or otherwise controlled by the processor 210. In this regard, the communication interface 214 may be in communication with the processor 210, such as via a bus. The communication interface 214 may include, for example, an antenna, a transmitter, a receiver, a transceiver and/or supporting hardware or software for enabling communications with one or more remote computing devices. The communication interface 214 may be configured to receive and/or transmit data using any protocol that may be used for communications between computing devices. In this regard, the communication interface 214 may be configured to receive and/or transmit data using any protocol that may be used for transmission of data over a wireless network, wireline network, some combination thereof, or the like by which the apparatus 202 and one or more computing devices may be in communication. The communication interface 214 may additionally be in communication with the memory 212, user interface 216, and/or widget display controller 218, such as via a bus.

The user interface 216 may be in communication with the processor 210 to receive an indication of a user input and/or to provide an audible, visual, mechanical, or other output to a user. As such, the user interface 216 may include, for example, a keyboard, a mouse, a joystick, a display, a touch screen display, a microphone, a speaker, and/or other input/output mechanisms. In embodiments wherein the user interface 216 comprises or is in communication with a display, the display may comprise, for example, a cathode ray tube (CRT) display, a plasma display panel (PDP), a liquid crystal display (LCD), a light-emitting diode (LED), an organic light-emitting diode display (OLED), a projector (e.g., a projector configured to project a display on a projection screen, wall, and/or other object), a holographic display, or the like. In embodiments wherein the user interface 216 comprises a touch screen display, the user interface 216 may additionally be configured to detect and/or receive an indication of a touch gesture or other input to the touch screen display. The user interface 216 may be in communication with the memory 212, communication interface 214, and/or widget display controller 218, such as via a bus.

The widget display controller 218 may be embodied as various means, such as circuitry, hardware, a computer program product comprising computer readable program instructions stored on a computer readable medium (e.g., the memory 212) and executed by a processing device (e.g., the processor 210), or some combination thereof and, in some embodiments, is embodied as or otherwise controlled by the processor 210. In embodiments wherein the widget display controller 218 is embodied separately from the processor 210, the widget display controller 218 may be in communication with the processor 210. The widget display controller 218 may further be in communication with one or more of the memory 212, communication interface 214, user interface 216, or image sensor 118, such as via a bus. In some example embodiments, the widget display controller 218 may comprise an image signal processor.

In some example embodiments, the widget display controller 218 may be configured to control the display of graphical widgets on a home screen of the apparatus 202. Depending on the implementation of the apparatus 202, an operating system used with the apparatus 202, and/or other variables, the appearance and functionality of the home screen may vary. However, by way of non-limiting example, the home screen may comprise a default and/or first screen displayed when the apparatus 202 is turned on or reset. In this regard, the home screen may be displayed on a display of the user interface. The home screen may, for example, comprise a wallpaper image, one or more icons or menu options for accessing various device functionalities, one or more icons or menu options for accessing applications on the device, and/or the like. Graphical widgets that may be displayed on the home screen may, for example, comprise small, stand-alone applications that may include a graphical user interface. In this regard, a widget may provide a small, simple, and/or flexible interface that may enable a user to view and interact with focused and/or dynamic information from their device and the internet. In some instances, a widget may serve as an entry point (e.g., a portal) to a wider experience. By way of example, some widgets may include a clock widget, a weather widget, a widget indicating whether a user has unread email, or the like.

The widget display controller 218 may be configured to detect and/or receive an indication of a user input (e.g., an input to the user interface 216) for causing display of a widget tray (e.g., a request to display the widget tray). The user input may, for example, comprise selection of a menu option, actuation of a button, selection of a soft key, a touch gesture to a touch screen display, or the like. In some example embodiments wherein the user interface 216 comprises a touch screen display, the user input may, for example, comprise a swipe gesture. The swipe gesture may comprise a swipe of at least a defined threshold length and/or a swipe in a particular direction. For example, the input may comprise a swipe gesture from the bottom of the home screen in a substantially upward direction (e.g., in a direction substantially toward the top of the home screen). As another example, in some embodiments wherein the user interface 216 comprises a touch screen display, the input for causing display of the widget tray may comprise a touch and hold gesture held for at least a threshold length of time. In some example embodiments, when the widget tray is not displayed, a minimized representation of the widget tray may be displayed, such as a graphic representing the widget tray in a taskbar, an icon or graphic displayed on a portion of the home screen, or the like. Accordingly, in such example embodiments, a user may provide an input selecting the minimized representation of the widget tray in order to cause display of the widget tray.

In response to a user input for causing display of the widget tray, the widget display controller 218 may be configured to cause display of the widget tray. The widget tray may contain one or more widgets available for addition to the home screen. Widgets contained by the widget tray may be displayed in the widget tray with an appearance substantially similar to how they would appear on the home screen, if added to the home screen. In this regard, the widget tray may contain and display one or more available graphical widgets rather than merely plain text list of available widgets.

The widget tray may be displayed concurrently with at least a portion of the home screen. As an example, the widget tray may be displayed in the foreground with at least a portion of the home screen displayed in the background. For example, the widget tray may be displayed overlying at least a portion of the home screen, but may be at least partially transparent and/or translucent such that the underlying home screen is at least partially visible through the widget tray. As another example, the widget display controller 218 may cause a reduced size representation of the home screen to be displayed while the widget tray is displayed. Accordingly, the widget tray may be displayed on one portion of a display and the reduced size representation of the home screen may be displayed on another portion of the display.

In some example embodiments, one or more widgets previously added to the home screen may be displayed on the at least a portion of the home screen displayed while the widget tray is displayed. Accordingly, in such example embodiments, a user may view widgets already added to the home screen and/or an arrangement thereof on the home screen when selecting a widget from the widget tray to add to the home screen.

A user may browse the available widgets in the widget tray and may select a widget for addition to the home screen. As an example, the user may provide a touch gesture input to a touch screen display that is associated with selection of a widget. Such touch gesture input may, for example, comprise tapping a widget in the widget tray that the user wishes to add to the home screen. As another example, a touch gesture input for selecting a widget may comprise performing a touch and hold gesture to select a desired graphical widget and then dragging the widget from the widget tray toward the displayed at least a portion of the home screen. In this regard, in some example embodiments, a user may “drag and drop” the widget onto the home screen. It will be appreciated that user inputs other than touch gestures may be used for selection of a widget. For example, a user may select a widget from the widget tray using a mouse or other input device. Accordingly, for example, a user may use a mouse to manipulate an onscreen cursor to click a widget, drag and drop the widget from the widget tray to the displayed at least a portion of the home screen, and/or the like.

The widget display controller 218 may be configured to determine a user selection of a widget from the widget tray. In this regard, the widget display controller 218 may be configured to detect and/or receive an indication of a user input selecting a widget. In response to the selection of the widget, the widget display controller 218 may be configured to cause the selected widget to be added to the home screen.

In some example embodiments, a user may further select a display size for a widget to be added to the home screen. Selection of a display size may be performed in a variety of manners in various example embodiments. In some example embodiments, however, selection of a display size may be integrated into the process for selecting a widget to add to the home screen. For example, a user may perform a pinch gesture on a touch screen display to define a desired display size for the widget when selecting the widget. In this regard, for example, the display size of the widget when added to the home screen may be defined by the distance between the user's fingers used to make the pinch gesture. In some example embodiments wherein a pinch gesture is used to define a display size for the widget, a user may make a pinch gesture concurrent with dragging the widget from the widget tray toward the displayed at least a portion of the home screen. The widget display controller 218 may accordingly be configured to determine a selection of a display size for a selected widget and cause the selected widget to be added to the home screen at the selected display size.

In some example embodiments, the widget display controller 218 may be additionally configured to cause the widget tray to be hidden in response to selection of a graphical widget for addition to the home screen.

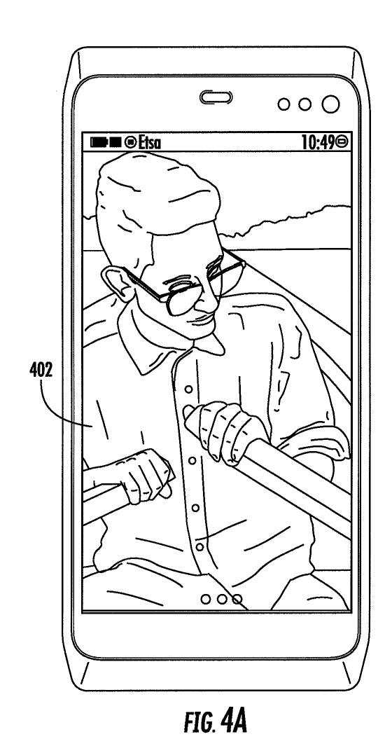

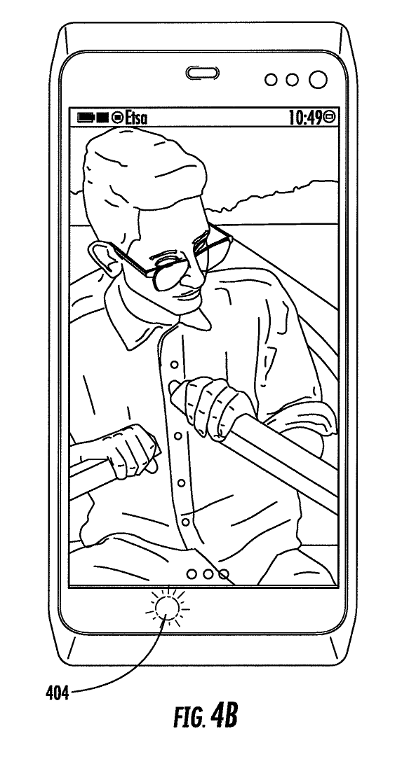

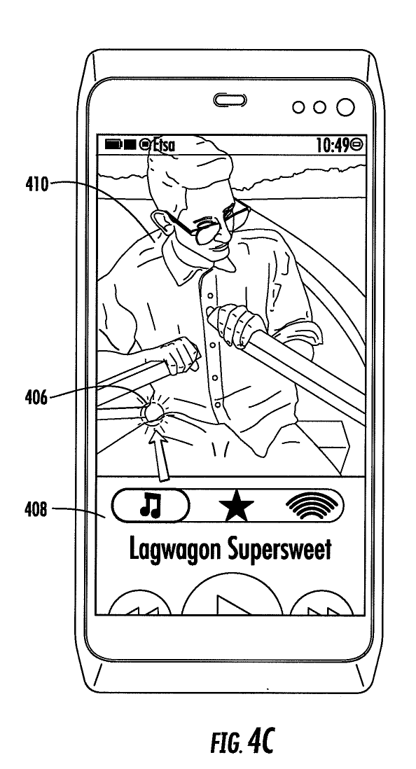

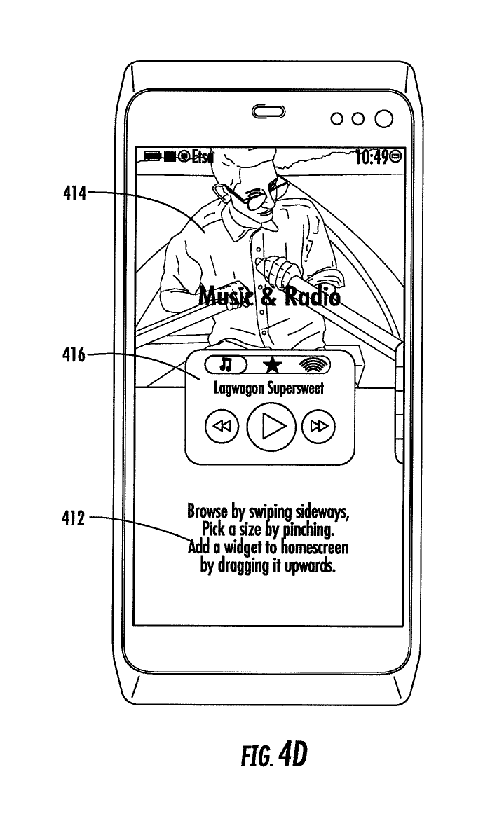

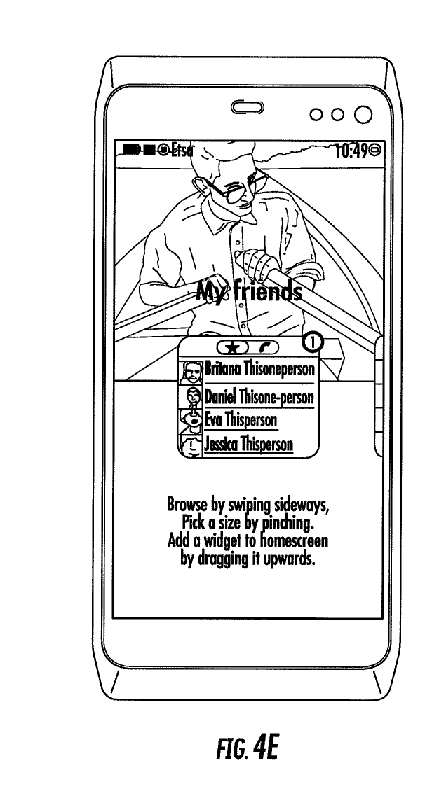

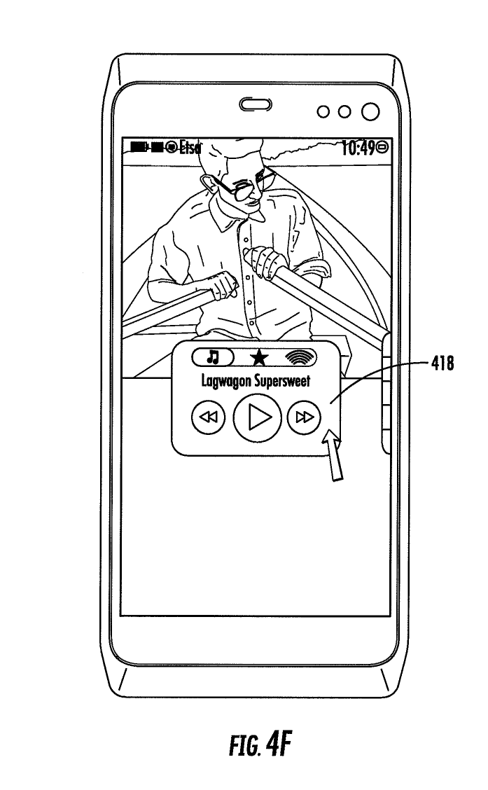

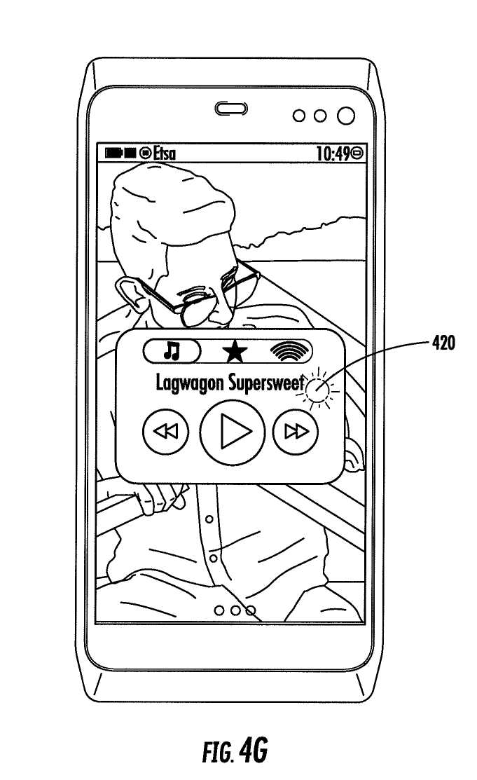

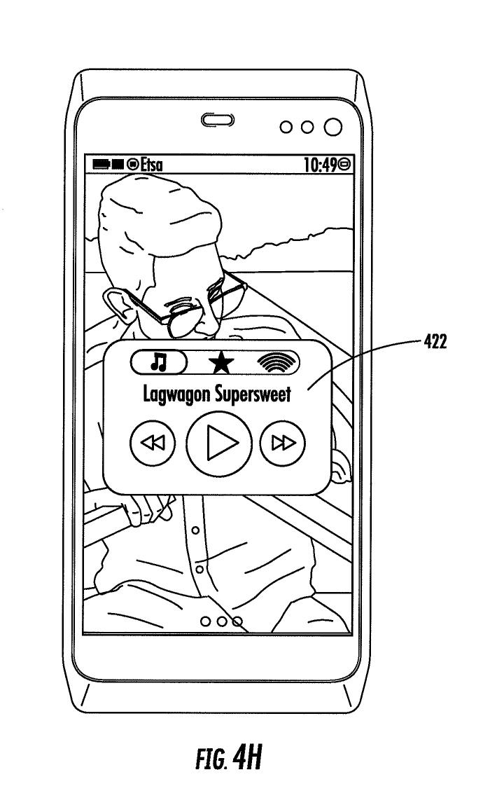

Referring now to FIGS. 4a-4h, FIGS. 4a-4h illustrate screen captures according to an example process flow for adding a widget to a home screen according to some example embodiments. FIGS. 4a-4h illustrate an embodiment wherein the home screen is a home screen displayed on a mobile device having a touch screen display. It will be appreciated, however, that example embodiments can be implemented on non-touch screen devices and/or on non-mobile devices. As such, the illustrations in FIGS. 4a-4h are provided by way of example, and not by way of limitation.

Referring first to FIG. 4a, a home screen 402 may be displayed. As illustrated by reference 404 in FIG. 4b, a user may perform a touch and hold gesture to cause display of the widget tray. Referring next to FIG. 4c, while maintaining the touch and hold gesture, the user may slide the touch and hold gesture in a substantially upward direction, as illustrated by reference 406. In response to this touch, hold, and slide gesture, the widget display controller 218 may cause display of a transition effect. In this regard, for example, a portion 408 of the widget tray may become progressively more visible as the user slides the touch and hold gesture. Further, the home screen may be reduced in size, as illustrated by reference 410, in order to provide display room for the widget tray.

Referring next to FIG. 4d, after completion of the touch, hold, and slide gesture, the widget tray 412 may be displayed concurrent with the reduced size representation 414 of the home screen. The widget tray may display one or more graphical widgets, such as the graphical widget 416. In some example embodiments, widgets in the widget tray may be organized by type or category. For example, in FIG. 4d, the widget 416 is categorized as a “Music & Radio” widget. The user may accordingly navigate through the categories of widgets in the widget tray, such as by performing a sideways slide gesture. Referring now to FIG. 4e, the “My friends” widget is displayed in the widget tray, such as in response to user navigation of available widgets. After navigating the available widgets, the user may select a widget for addition to the home screen, such as by performing a touch, hold, and slide gesture selecting the desired widget and dragging the desired widget in a substantially upward direction toward the home screen, as indicated by reference 418 in FIG. 4f. The user may slide the selected widget in a substantially upward direction toward the displayed reduced size representation of the home screen. As illustrated in FIG. 4g, as the user slides the widget (reference 420), the widget display controller 218 may cause the widget tray to be hidden, and may again cause display of the home screen at full size (e.g., at the size at which it was displayed prior to display of the widget tray). Referring now to FIG. 4h, the selected widget 422 has been added to the home screen.

In some example embodiments, the widget display controller 218 may be configured to cause a widget to be removed from the home screen in response to a user input for removing a widget. As an example, a user may drag a widget from a display position on the home screen to a display area designated for removal of widgets from the home screen.

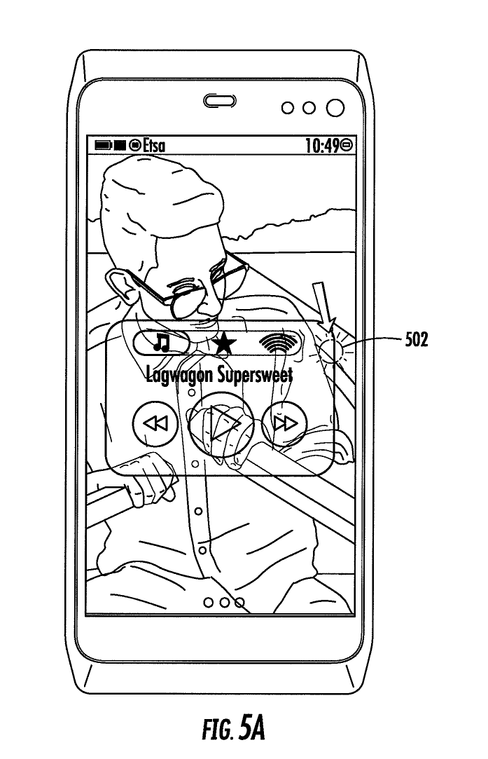

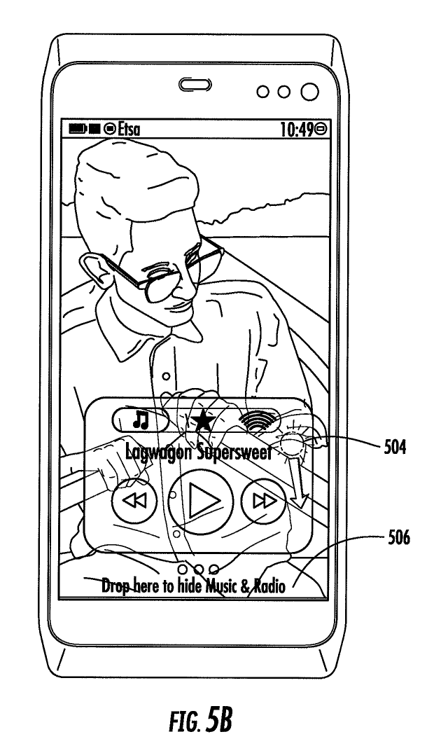

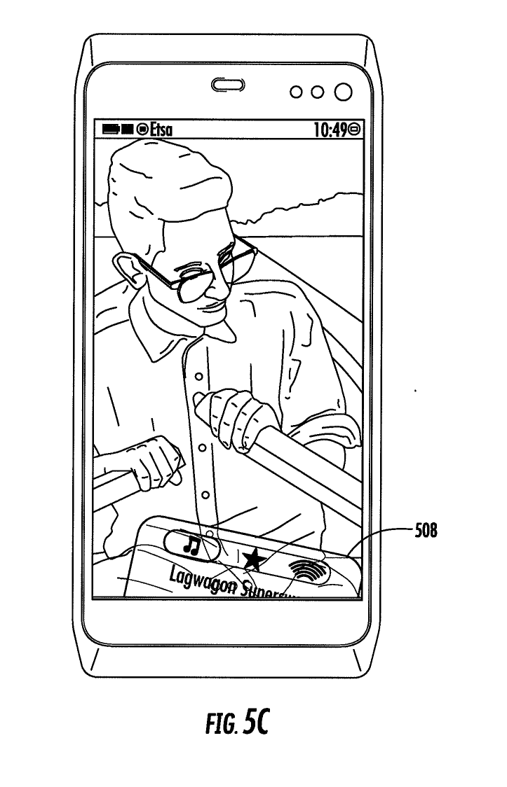

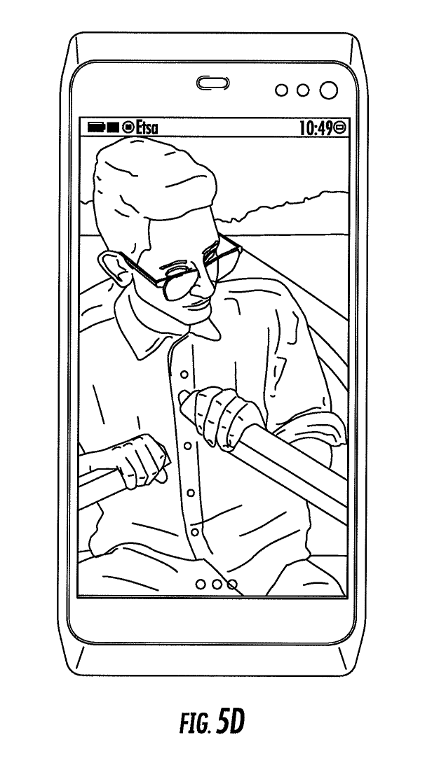

FIGS. 5a-5d illustrate screen captures according to an example process flow for removing a widget from a home screen according to some example embodiments. FIGS. 5a-5d illustrate an embodiment that may be implemented on a mobile device having a touch screen display. It will be appreciated, however, that example embodiments can be implemented on non-touch screen devices and/or on non-mobile devices. As such, the illustrations in FIGS. 5a-5d are provided by way of example, and not by way of limitation.

Referring first to FIGS. 5a, the user may select a widget displayed on a home screen for removal, such as by performing a touch and hold gesture on the widget, as indicated by reference 502. As indicated by the direction arrow at reference 502, the user may drag the selected widget toward a portion of the display designated for removal of a widget from the home screen (e.g., in a substantially downward direction from the spot 502 of the initial touch and hold gesture). Referring now to FIG. 5b, FIG. 5b illustrates the widget having been dragged toward the bottom of the screen, as indicated by reference 504. The widget display controller 118 may cause display of a graphic 506 for removing the widget in response to the user dragging the widget toward the bottom of the screen. In this regard, if the user drags the widget to the graphic 506, the widget may be removed from the home screen. Referring to FIG. 5c, if the user drags the widget to the graphic 506, the widget display controller 508 may, in some example embodiments, cause display of an animation effect 508 illustrating the widget falling off of the screen. FIG. 5d illustrates the home screen subsequent to removal of the widget.

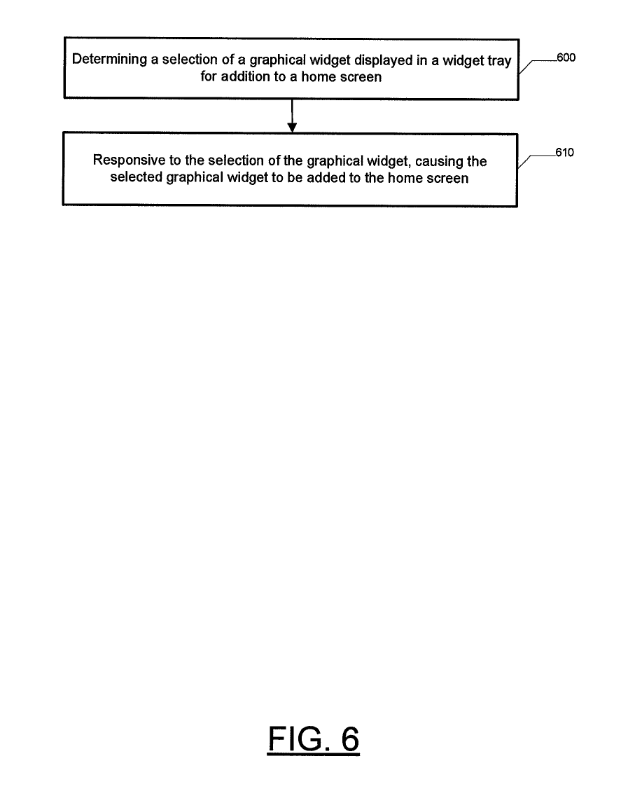

Referring now to FIG. 6, FIG. 6 illustrates a flowchart according to an example method for facilitating management of widgets according to some example embodiments. The operations illustrated in and described with respect to FIG. 6 may, for example, be performed by, with the assistance of, and/or under the control of one or more of the processor 210, memory 212, user interface 216, or widget display controller 218. Operation 600 may comprise determining a selection of a graphical widget displayed in a widget tray for addition to a home screen. At least a portion of the home screen may be displayed concurrently with the widget tray. Operation 600 may optionally further comprise determining a selection of a display size for the widget. The processor 210, memory 212, user interface 216, and/or widget display controller 218 may, for example, provide means for performing operation 600. Operation 610 may comprise responsive to the selection of the graphical widget, causing the selected graphical widget to be added to the home screen. In example embodiments wherein operation 600 further comprises determining a selection of a display size, operation 610 may comprise causing the selected graphical widget to be added to the home screen at the selected display size. The processor 210, memory 212, user interface 216, and/or widget display controller 218 may, for example, provide means for performing operation 610.

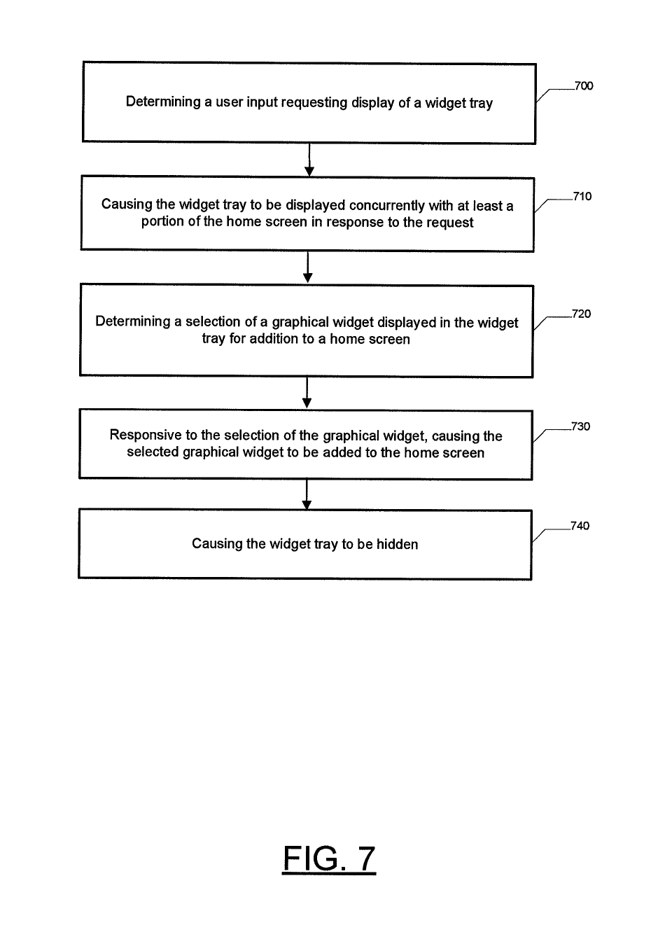

FIG. 7 illustrates a flowchart according to another example method for facilitating management of widgets according to some example embodiments. The operations illustrated in and described with respect to FIG. 7 may, for example, be performed by, with the assistance of, and/or under the control of one or more of the processor 210, memory 212, user interface 216, or widget display controller 218. Operation 700 may comprise determining a user input requesting display of a widget tray. The processor 210, memory 212, user interface 216, and/or widget display controller 218 may, for example, provide means for performing operation 700. Operation 710 may comprise causing the widget tray to be displayed concurrently with at least a portion of the home screen in response to the request. The processor 210, memory 212, user interface 216, and/or widget display controller 218 may, for example, provide means for performing operation 710. Operation 720 may comprise determining a selection of a graphical widget displayed in the widget tray for addition to the home screen. Operation 720 may optionally further comprise determining a selection of a display size for the widget. The processor 210, memory 212, user interface 216, and/or widget display controller 218 may, for example, provide means for performing operation 720. Operation 730 may comprise responsive to the selection of the graphical widget, causing the selected graphical widget to be added to the home screen. In example embodiments wherein operation 720 further comprises determining a selection of a display size, operation 730 may comprise causing the selected graphical widget to be added to the home screen at the selected display size. The processor 210, memory 212, user interface 216, and/or widget display controller 218 may, for example, provide means for performing operation 730. Operation 740 may comprise causing the widget tray to be hidden. The processor 210, memory 212, user interface 216, and/or widget display controller 218 may, for example, provide means for performing operation 740.

FIGS. 6-7 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 212) and executed by a processor in the computing device (for example, by the processor 210). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 202) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 202) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 210) may provide all or a portion of the elements. In another embodiment, all or a portion of the elements may be configured by and operate under control of a computer program product. The computer program product for performing the methods of an example embodiment of the invention includes a computer-readable storage medium (for example, the memory 212), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
determining, by a processor, a selection of a graphical widget displayed in a widget tray for addition to a home screen, the widget tray containing one or more widgets available to add to the home screen and being displayed concurrently with at least a portion of the home screen, the selected graphical widget being displayed in the widget tray with an appearance substantially similar to how the selected graphical widget would appear if added to the home screen; and
responsive to the selection of the graphical widget, causing the selected graphical widget to be added to the home screen.

2. The method of claim 1, further comprising causing a reduced size representation of the home screen to be displayed, wherein the at least a portion of the home screen displayed concurrently with the widget tray comprises the reduced size representation of the home screen.

3. The method of claim 1, further comprising causing display of one or more widgets previously added to the home screen on the at least a portion of the home screen displayed while the widget tray is displayed.

4. The method of claim 1, wherein determining a selection of the graphical widget comprises determining that the graphical widget has been dragged from the widget tray toward the at least a portion of the home screen that is displayed.

5. The method of claim 1, further comprising:
determining a selection of a display size for the selected graphical widget; and
wherein causing the selected graphical widget to be added to the home screen comprises causing the selected graphical widget to be added to the home screen at the selected display size.

6. The method of claim 5, wherein determining a selection of a display size for the selected graphical widget comprises determining a size defined by a pinch gesture.

7. The method of claim 1, further comprising:
causing the widget tray to be hidden in response to the selection of the graphical widget.

8. The method of claim 1, further comprising:
receiving an indication of a request to display the widget tray; and
causing display of the widget tray concurrent with the at least a portion of the home screen in response to the request.

9. The method of claim 1, further comprising:
subsequent to addition of the selected graphical widget to the home screen, determining that the selected graphical widget has been dragged to a display area designated for removal of a graphical widget from the home screen; and
causing the selected graphical widget to be removed from the home screen in response to the selected graphical widget being dragged to the display area.

10. An apparatus comprising at least one processor and at least one memory storing computer program code, wherein the at least one memory and stored computer program code are configured, with the at least one processor, to cause the apparatus to at least:
determine a selection of a graphical widget displayed in a widget tray for addition to a home screen, the widget tray containing one or more widgets available to add to the home screen and being displayed concurrently with at least a portion of the home screen, the selected graphical widget being displayed in the widget tray with an appearance substantially similar to how the selected graphical widget would appear if added to the home screen; and
responsive to the selection of the graphical widget, cause the selected graphical widget to be added to the home screen.

11. The apparatus of claim 10, wherein the at least one memory and stored computer program code are configured, with the at least one processor, to further cause the apparatus to cause a reduced size representation of the home screen to be displayed, wherein the at least a portion of the home screen displayed concurrently with the widget tray comprises the reduced size representation of the home screen.

12. The apparatus of claim 10, wherein the at least one memory and stored computer program code are configured, with the at least one processor, to further cause the apparatus to cause one or more widgets previously added to the home screen to be displayed on the at least a portion of the home screen displayed while the widget tray is displayed.

13. The apparatus of claim 10, wherein the at least one memory and stored computer program code are configured, with the at least one processor, to cause the apparatus to determine a selection of the graphical widget at least in part by determining that the graphical widget has been dragged from the widget tray toward the at least a portion of the home screen that is displayed.

14. The apparatus of claim 10, wherein the at least one memory and stored computer program code are configured, with the at least one processor, to further cause the apparatus to:
determine a selection of a display size for the selected graphical widget; and
cause the selected graphical widget to be added to the home screen by causing the selected graphical widget to be added to the home screen at the selected display size.

15. The apparatus of claim 14, wherein the at least one memory and stored computer program code are configured, with the at least one processor, to further cause the apparatus to determine a selection of a display size for the selected graphical widget at least in part by determining a size defined by a pinch gesture.

16. The apparatus of claim 10, wherein the at least one memory and stored computer program code are configured, with the at least one processor, to further cause the apparatus to:
causing the widget tray to be hidden in response to the selection of the graphical widget.

17. The apparatus of claim 10, wherein the at least one memory and stored computer program code are configured, with the at least one processor, to further cause the apparatus to:
receive an indication of a request to display the widget tray; and
cause display of the widget tray concurrent with the at least a portion of the home screen in response to the request.

18. The apparatus of claim 10, wherein the at least one memory and stored computer program code are configured, with the at least one processor, to further cause the apparatus to:
subsequent to addition of the selected graphical widget to the home screen, determine that the selected graphical widget has been dragged to a display area designated for removal of a graphical widget from the home screen; and
cause the selected graphical widget to be removed from the home screen in response to the selected graphical widget being dragged to the display area.

19. The apparatus of claim 10, wherein the apparatus comprises or is embodied on a mobile computing device, the mobile computing device comprising user interface circuitry and user interface software stored on one or more of the at least one memory, wherein the user interface circuitry and user interface software are configured to:
facilitate user control of at least some functions of the mobile computing device through use of a display; and
cause at least a portion of a user interface of the mobile computing device to be displayed on the display to facilitate user control of at least some functions of the mobile computing device.

20. A computer program product comprising at least one non-transitory computer-readable storage medium having computer-readable program instructions stored therein, the computer-readable program instructions comprising:
program instructions configured to determine a selection of a graphical widget displayed in a widget tray for addition to a home screen, the widget tray containing one or more widgets available to add to the home screen and being displayed concurrently with at least a portion of the home screen, the selected graphical widget being displayed in the widget tray with an appearance substantially similar to how the selected graphical widget would appear if added to the home screen; and
program instructions configured, responsive to the selection of the graphical widget, to cause the selected graphical widget to be added to the home screen.
